(19) United States
(12) Patent Application Publication
(10) Pub. No.: US 2026/0115880 A1
(43) Pub. Date: Apr. 30, 2026

(54) MULTI-HEAD SERVICE TOOL

(71) Applicant: Alberto Torres-Barry, Naples, FL (US)

(72) Inventor: Alberto Torres-Barry, Naples, FL (US)

(21) Appl. No.: 18/929,976

(22) Filed: Oct. 29, 2024

(51) Int. Cl. B25F 1/02

(52) U.S. Cl. CPC B25F 1/02

(57) ABSTRACT

A multi-head service tool is shown and described. In one exemplary embodiment, the service tool includes a first working end having a first working tool member and a second working tool member. The first working tool member includes a longitudinal tool body with a working end and a non-working end with a spring removably attached. The middle body includes a third working tool member. The middle body and the second working tool member of the first working end are integrally connected and include a pair of openings on each end connected by a passageway configured to a substantial portion of the first working tool member. Opposite the first working end, the service tool includes a second working end having a fourth working tool member that includes a multi-functional working tool head.

### FIELD OF THE INVENTION

The present invention relates generally to a service tool and, more particularly, to a multi-head service tool for HVAC systems.

### SUMMARY OF THE INVENTION

The present invention is directed to a multi-head service tool for HVAC systems. Introducing a first embodiment of the invention, the present invention consists of a first working end, including a first and a second working tool member. The service tool includes a middle working body including a third working tool member, wherein the middle working body and the second working tool member of the first working end are integrally connected. Opposite the first working end is a second working end that includes a fourth working tool member. The second working end is removably attached to an end of the middle working body.

In another aspect, the first working tool member of the first working end may comprise a longitudinal tool hexagonal-shaped body that includes a working end and a non-working end that includes a spring removably attached thereto.

In another aspect, the middle working body and the second tool member may include an opening and a centralized passageway extending therethrough that is configured to receive a portion of the first working tool member therein.

In another aspect, the second working end may be threadedly engaged to the middle working body. The second working end may also include a multi-functional working tool head configured to engage valve stems and caps on the valve stems. Alternatively, the first and second working tool members may be configured to engage liquid lines, vapor lines, and service valves.

In another aspect, the third working tool member may include a surface area configured to receive force from a wrench.

In still another aspect, the first working tool member may include a shaped body that is of a smaller diameter than the second working tool member.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a perspective view of an exemplary embodiment of a multi-head service tool in accordance with the present invention;

FIG. 2 presents a side elevation view of the multi-head service tool;

FIGS. 3 and 4 presents a perspective view of at least two working tool ends of the multi-head service tool; and

FIG. 5 presents a perspective view of a spring and retention member disposable inside of the multi-head service tool that engages an end of a distal tool end.

Like reference numerals refer to like parts throughout the several views of the drawings.

### DETAILED DESCRIPTION

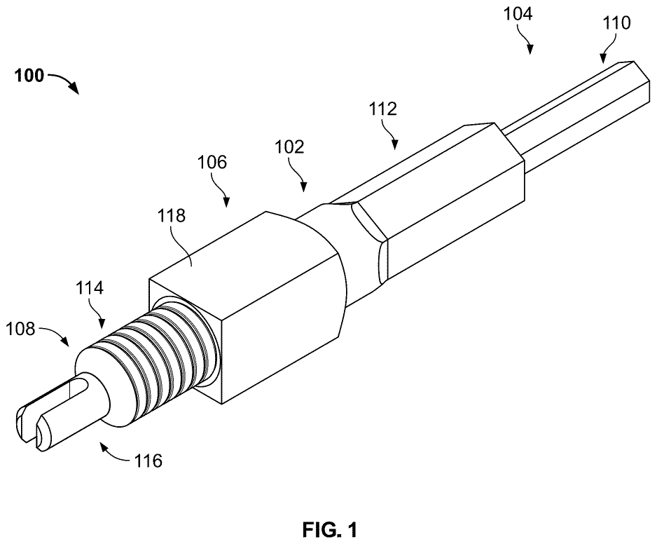

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring initially to FIG. 1, directed to a multi-head service tool 100 (hereinafter referred to as “service tool”). The service tool 100 includes a main body 102 comprising a distal working end 102, a middle portion working body 106, and a proximal working end 108. The distal working end 104 may include a first tool member 110 that engages with a second tool member 112. The proximal working end 108, in one exemplary embodiment, may include a third tool member 114 that includes a multi-functional working member 116 that engages with the middle portion body 106 of the service tool 100, which itself is a working tool body 118 that can be used in conjunction with another tool, such as a wrench (i.e., a fifth working tool member). As such, the multi-head service tool 100 in the shown exemplary embodiment comprises a five-in-one working service tool.

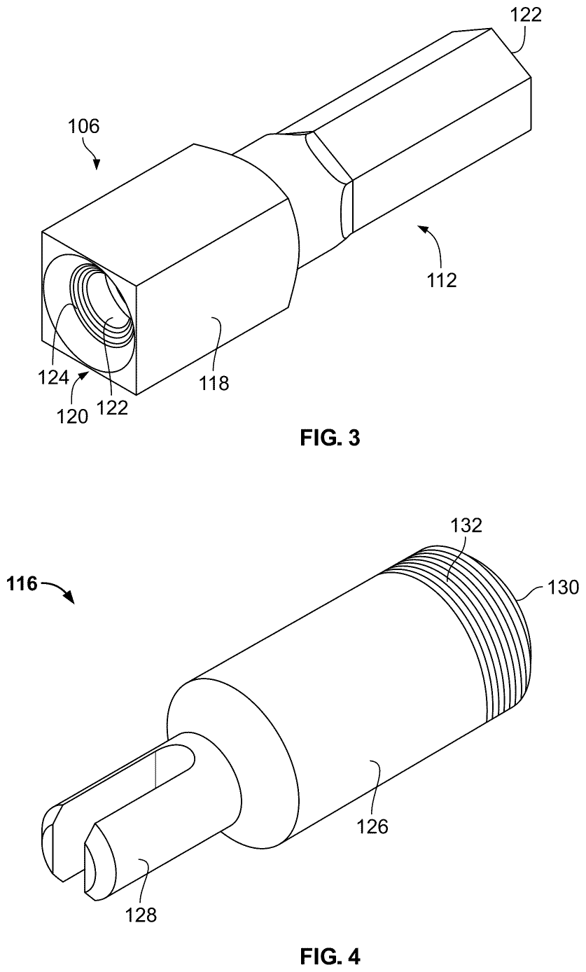

Referring now to FIGS. 3 and 4, the middle portion body 106 includes a working tool body 118 and a tool member 112 extending and continuous from the tool body 118. In one exemplary embodiment, tool member 112 may include a hex-shaped body, and the working tool body 118 may include a hex-shaped body. Alternatively, tool member 112 may include a hex-shaped body, and the working tool body 118 may include a square-shaped body. In another alternative embodiment, tool body 118 and tool member 112 may include alternative-shaped bodies designed and otherwise configured to be used to apply a force and/or torque. The working tool body 118 of the middle portion 106 of the service tool 100 includes an opening 120 connected to a passageway 122 that extends through the working tool body 118 and tool member 112. At the opening 120 of the working tool body 118, in one exemplary embodiment, the opening 120 is threaded 124 or otherwise machined to receive another working tool member, e.g., the proximal working end 108 of the service tool.

As exemplarily shown in FIG. 4, the proximal working portion 108 of the service tool may include a multi-functional working member 116 that includes a main body 126 that includes a tool head 128 on one end and a non-working tool end 130 on the other. The non-working tool end 130 in one exemplary embodiment may include threads 132 that engage the threads 124 on the middle portion working body 116 of the service tool to join the third tool member 114 of the service tool 100 with the middle portion body 106. The tool head 128 of the service tool 100 in one exemplary embodiment may include a valve stem remover designed for removing caps and cores from valve stem mechanisms. The opening 124 in the middle portion 106 of the service tool 100 comprises a tapped hole approximately 5/16 to 5/18 of an inch, and the non-working end 130 of the main body 126 of the working head 106 is approximately 5/16 to 5/18 of an inch having machine threaded stud. In one exemplary embodiment, tool member 112 comprises a 3/16 in diameter, and the working tool body 118 may include a 5/16 in diameter.

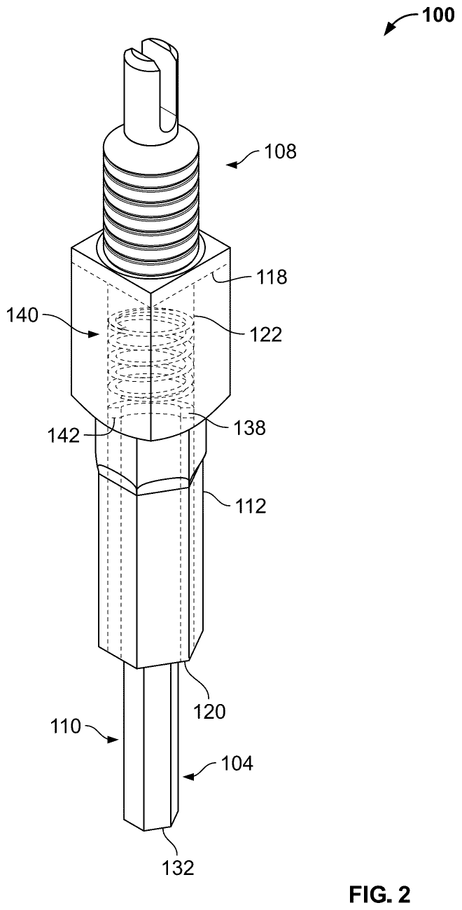

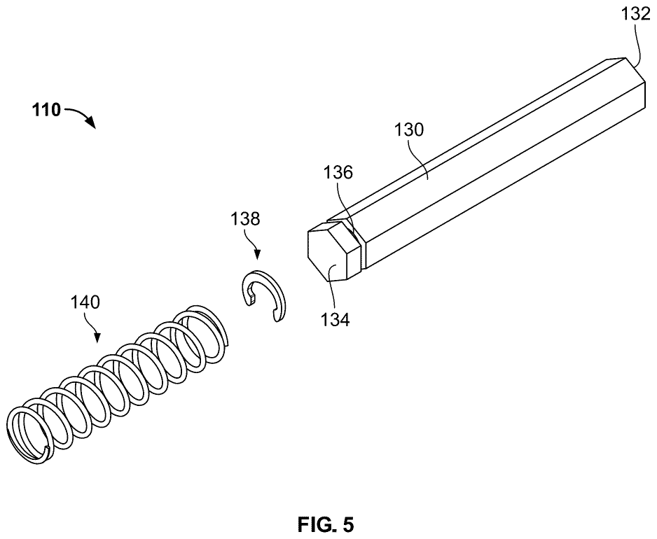

Referring to FIGS. 2 and 5, the service tool 100 includes a distal end 104 with a first tool member 110. The tool member 110 comprises an elongated body 130 with a working end 132 and a non-working end 134. Proximate to the non-working end 134, the elongated body 130 includes a circumferential slot 136 configured to receive a retaining clip 138 or a c-clip. The retaining clip 138 is used to removably secure a spring 140 to the non-working end 134 of the tool member 110. In one exemplary embodiment, the tool member 110 may be shaped to include a hexagonal-shaped body, square-shaped body, or any other shaped body for services HVAC systems. Turning to FIG. 2, a portion of tool member 110 is disposed of within passageway 122, extending through the working tool body 118 and tool member 112. Insertion of the tool member 110 into the passageway 112 of the middle portion body 106 of the service tool may include removal or decoupling of the proximal working portion 108 of the service tool from the middle portion body 106, as described above. The working end 132 is inserted through the opening 120 on working tool body 118 (FIG. 3) until the retaining member 138 makes contact with a raised edge 142 that prevents the tool member 110 from moving past that point. Once in position, the proximal working portion 108 is attached or coupled to the middle portion body 108, securing the spring 140 in place. As configured, the first tool member can translate or move within the passageway of the second tool member 112.

An exemplary method of use of the service valve tool 100 is now provided. In one exemplary form, a user connects the service tool 100 to a service wrench. The user then places the service tool in a liquid line valve and proceeds to turn the wrench counterclockwise until the valve is fully open. Following the valve being open, the service tool is removed from the liquid line valve and placed in the suction line valve, with the user putting downward pressure on the valve, causing the first tool member 110 to telescopically retract into the second tool member 112 of the service tool 100. The second tool member 112 is then used to open the suction line valve by using a wrench engaging the working tool body 118 of the service line and turning the entire tool counterclockwise.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A multi-head service tool, comprising:
a first working end including a first and a second working tool member;
a middle body including a third working tool member, wherein the middle body and the second working tool member of the first working end are integrally connected; and
a second working end, opposite the first working end, including a fourth working tool member, wherein the second working end is removably attached to an end of the middle body.

2. The multi-head service tool of claim 1, wherein the first working tool member of the first working end comprises a longitudinal tool body that includes a working end and a non-working end that includes a spring removably attached thereto.

3. The multi-head service tool of claim 1, wherein the middle body and the second tool member include an opening and a centralized passageway extending therethrough and is configured to receive a portion of the first working tool member therein.

4. The multi-head service tool of claim 1, wherein the second working end is threadedly engaged to the middle body.

5. The multi-head service tool of claim 1, wherein the fourth working tool member includes a multi-functional working tool head.

6. The multi-head service tool of claim 5, wherein the multi-functional working tool head is configured to engage valve stems, valve cores, and caps on valve stems.

7. The multi-head service tool of claim 1, wherein the first and second working tool members are configured to engage liquid lines, vapor lines, and service valves.

8. The multi-head service tool of claim 1, wherein the third working tool member includes a surface area configured to receive force from a tool.

9. The multi-head service tool of claim 1, wherein the first working tool member includes a shaped body that is of a smaller diameter than the second working tool member.

10. A multi-head service tool, comprising:
a first working end including a first working tool member and a second working tool member, the first working tool member includes a longitudinal tool body that includes a working end and a non-working end that includes a spring removably attached thereto;
a middle body including a third working tool member, wherein the middle body and the second working tool member of the first working end are integrally connected and include a pair of openings on each end connected by a passageway, disposed within the passageway is the spring and a portion of the first working tool member; and
a second working end, opposite the first working end, including a fourth working tool member having a multi-functional working tool head, and wherein the second working end is removably attached to an end of the middle body.

11. The multi-head service tool of claim 10, wherein the second working end is threadedly engaged to the middle body.

12. The multi-head service tool of claim 10, wherein the second first working tool member is spring-loaded and configured to retract and extend from the passageway.

13. The multi-head service tool of claim 10, wherein the third working tool member includes a surface area configured to receive force from a tool.

14. The multi-head service tool of claim 10, wherein the first working tool member includes a hexagonal-shaped body that is of a smaller diameter than a hexagonal-shaped body of the second working tool member.

15. The multi-head service tool of claim 10, wherein the multi-functional working tool head is configured to engage valve stems and caps on valve stems.

16. The multi-head service tool of claim 10, wherein the first and second working tool members are configured to engage liquid lines, vapor lines, and service valves.

17. The multi-head service tool of claim 10, wherein multi-head service tool includes at least 5 working tool members.

18. A multi-head service tool, comprising:
a first working end including a hexagonal-shaped first working tool member with a diameter of 3/16 inch and a hexagonal-shaped second working tool member with a diameter of 5/16 inch, the first working tool member includes a longitudinal tool body that includes a working end and a non-working end that includes a spring removably attached thereto;
a middle body including a third working tool member, wherein the middle body and the second working tool member of the first working end are integrally connected and include a pair of tapped openings that are approximately 5/16 inch on each end connected by a passageway, disposed within the passageway is the spring and a portion of the first working tool member; and
a second working end, opposite the first working end, including a fourth working tool member having a multi-functional working tool head on one end and a threaded end on the other, wherein the threaded end is approximately the same size as the tapped opening and is removably attached to an end of the middle body.

19. The multi-head service tool of claim 18, wherein the multi-functional working tool head is configured to engage valve stems and caps on valve stems.

20. The multi-head service tool of claim 18, wherein the first and second working tool members are configured to engage liquid lines, vapor lines, and service valves.
